(19) United States
(12) Patent Application Publication
(10) Pub. No.: US 2006/0066517 A1
(43) Pub. Date: Mar. 30, 2006

(54) Method and apparatus for generating subfield codes

(76) Inventors: Sebastien Weitbruch, Niedereschach (FR); Carlos Correa, Villingen-Schwenningen (DE); Cedric Thebault, Villingen-Schwenningen (DE)

Correspondence Address: THOMSON LICENSING INC., PATENT OPERATIONS, PO BOX 5312, PRINCETON, NJ, 08543-5312, US

(21) Appl. No.: 11/224,547

(22) Filed: Sep. 12, 2005

(30) Foreign Application Priority Data
Sep. 15, 2004 (EP) 04292221.1

(51) Int. Cl. G09G 3/28

(52) U.S. Cl. 345/63

(57) ABSTRACT

The present invention relates to a method and an apparatus for generating subfield codes for pictures displayed on a display device like plasma display panels (PDPs) or display devices wherein the grey level of the pixels of the pictures displayed by the display device is obtained by modulating the number of light pulses per frame or sustain pulses (PWM for Pulse Width Modulation), the number of sustain pulses per subfield of the frame depending on the power average level of the picture to be displayed. The video levels of the pictures are first transcoded into luminance codes and then coded into subfield codes. In order to reduce the memory size required for implementing this transcoding, offset values between luminance codes are stored in a look-up table instead of storing the luminance codes. The luminance codes are then regenerated in the controller of the display device.

### FIELD OF THE INVENTION

The present invention relates to a method for generating subfield codes for pictures displayed on a display device like plasma display panels (PDPs) or display devices wherein the grey level of the pixels of the pictures displayed by the display device is obtained by modulating the number of light pulses per frame or sustain pulses (PWM for Pulse Width Modulation). It also relates to an apparatus for implementing said method.

### BACKGROUND OF THE INVENTION

The present invention is particularly useful in the field of plasma display panels (PDPs) or other display devices wherein each video level is represented by a combination of bits according to a specific coding.

In this case, when the algorithms used to improve picture quality are based on data stored in memories such as look-up tables (LUTs), the size of such tables may be quite huge.

The invention will be described in relation with PDP but may be applicable to other types of display as mentioned above. As well known, a plasma display panel is constituted by two insulating plates sealed together to form a space filled with gas. Ribs are provided inside the space to form a matrix array of discharge cells which could only be “ON” or “OFF”. Also, unlike other displays such as CRT (Color ray tube) or LCD (Liquid Crystal Display) in which grey levels are expressed by analogue control of the light emission, a PDP controls the grey level by modulating the number of light pulses per frame. These light pulses are known as sustain pulses. The time-modulation will be integrated by the eye over a period corresponding to the eye time response.

In the field of video processing, an 8-bit representation of a luminance level is very common. In this case, each video level will be represented by a combination of the following 8-bits:
2^{o}=1, 2¹=2, 2²=4, 2³=8, 2⁴=16, 2⁵=32, 2⁶=64, 2⁷=128

To realize such a coding scheme with the PDP technology, the frame period which has a duration function of the frequency of 16 ms for 60 Hz or 20 ms for 50 Hz, is divided in 8 sub-periods known as subfields SF. Each subfield SF corresponds to one of the 8 bits as shown in FIG. 1. The duration of the light emission for the bit 2¹=2 is the double of that for the bit 2°=1, etc. . . . With a combination of these 8 sub-periods, it is possible to build 256 different grey levels. For example, the grey level 92 will thus have the corresponding digital code word 00111010=4+8+16+64. More specifically, in known plasma display technology, each subfield SF is a period of time comprising:

a writing/addressing period of fixed length in which the plasma cell is either brought to an excited state with a high voltage or to a neutral state with lower voltage;

a sustain period depending on the subfield weighting; a gas discharge is made with short voltage pulses or sustain pulses with equal amplitude and equal duration, the number of pulses corresponding to the subfield weighting;

an erasing period of fixed length in which the charge of the cells is quenched.

In addition, a priming pulse P may be used at the beginning of the frame period. Such priming makes a pre-excitation of the plasma cell to prepare the cells for homogeneous writing of each subfield.

So video levels are mapped to a set of subfield codes based on the subfield weight. Thus, luminance is generated by means of a discrete number of sustain pulses distributed by a discrete number of subfields. If the number of sustain pulses which have to be distributed by the subfields of a frame corresponds to the number of video levels, the repartition would be straightforward as in the above example wherein 255 sustain pulses have to be distributed by a subfield group 1-2-4-8-16-32-64-128 allowing 256 different luminance values. However, if for instance 293 sustain pulses have to be distributed, the process is substantially more complicated. Sustain pulses can not be neatly divided among the subfields giving rounding errors. Further complication arises due to the fact that the process of writing and erasing a subfield also generates some luminance equally added to every bit subfield regardless of its weight. So PDP panels are slightly non-linear, i.e. 100 sustain pulses will not produce 100 times more luminance than a single sustain pulse.

As similar to CRTs, PDPs require use of a Peak White Enhancement (PWE) circuit, which controls peak white level as a function of average image power. The number of peak white sustain pulses is adapted to said average picture power and the sustain pulses can not be neatly divided amongst the subfields as mentioned above. Due to these problems (rounding errors, plasma non-linearities due to the existence of parasitic luminance during priming, writing and erasing operations), the known solution consisting to map the number of required sustain pulses to chosen subfield code weight structure produces clearly perceptible grey scale portrayal non-linearities.

For palliating these non-linearities, a new concept based on luminance codes has been developed in the patent application EP 1 353 315. One type of non-linearities is known as “grayscale inversions”. A grayscale inversion means that, under certain circumstances, a video level N+1 could be darker than a video level N leading in disturbing grayscale non-linearity.

The problem of level inversion can be easily explained by the means of one example. The following table 1 gives the number of sustain pulses per subfield for a frame comprising 12 subfields with the following weights 1 2 3 5 8 13 19 25 32 40 49 58 and for the following APL (Average Power level) values 0%, 20%, 40%, 60%, 80% and 100%.

TABLE 1

| | Weight | | | | | | | | | | | | |
|---|---|---|---|---|---|---|---|---|---|---|---|---|---|
| | 1 | 2 | 3 | 5 | 8 | 13 | 19 | 25 | 32 | 40 | 49 | 58 | Σ = 255 |
| APL | Number of sustain pulses per subfield | | | | | | | | | | | | Total |
| 0% | 5 | 11 | 16 | 27 | 44 | 71 | 104 | 136 | 175 | 218 | 267 | 316 | Σ = 1391 |
| 20% | 3 | 7 | 10 | 17 | 27 | 45 | 65 | 86 | 110 | 137 | 168 | 199 | Σ = 875 |
| 40% | 2 | 4 | 6 | 11 | 17 | 28 | 41 | 53 | 68 | 85 | 105 | 124 | Σ = 544 |
| 60% | 1 | 3 | 4 | 7 | 11 | 17 | 25 | 33 | 43 | 53 | 66 | 78 | Σ = 341 |
| 80% | 1 | 2 | 2 | 4 | 7 | 11 | 16 | 21 | 26 | 33 | 40 | 48 | Σ = 210 |
| 100% | 1 | 1 | 1 | 2 | 4 | 6 | 9 | 12 | 16 | 20 | 24 | 28 | Σ = 124 |

In the situation presented in Table 1, for an APL value of 100%, the video level 6 (111000000000) corresponds to 3 sustain pulses (1+1+1) and 3 writing operations. On the other hand, the video level 7 (010100000000) will also correspond to 3 sustain pulses (1+2) but with only 2 writing operations. Since each writing operation brings an emission of light (around 20% of a sustain cycle), the video level 6 will be lighter than the video level 7. The apparition of such inversions will depend on the APL level so that a change in the contrast, luminance or picture content will introduce new non-linearity in the grayscale portrayal. The concept of Metacodes has been developed in order to avoid these disturbances in EP 1 353 315. In fact, this concept is based on a model of the light emission produced by all PDP stages like priming, erasing, writing and sustaining. This concept includes also a model of the phosphor saturation for low picture loads (high peak-white).

In order to illustrate the concept, the following model of cell behavior is taken as an example: Priming operation: 0.1 cd/m²
Sustain pulse: 1 cd/m²
Writing pulse: 0.25 cd/m²

The use of the priming light emission model is important since this operation defines the black level of the panel, which is a key parameter for the gamma curve definition. The number of priming operations used in a PDP can vary from one supplier to another one but the use of only one single priming operation per frame has already been presented in the patent application EP 1 250 696 and will be used to simplify our explanations.

The APL table used for our examples is derived from Table 1 and the following sustain table corresponding to an APL value of 97% shall be considered:
1-1-2-3-4-7-10-13-16-20-25-30 (Σ=132 sustain pulses)

The luminance model for a given codeword can be defined as follows:
Luminance(codeword)=0.1+0.25×W+1×S
where W is the total number of writing operations and
S is the total number of sustain pulses.

For instance, the codeword [110110100000] will correspond to 1 priming operation, 5 writing operations and 19 sustain pulses (1+1+0+3+4+0+10+0+0+0+0 +0), which means 0.1+0.25×5+19=20.35 cd/m².

For each given APL value (97% in our example), a computation of the luminance level of all codewords is done based on the previous defined model. The luminance levels for the input video levels 0 to 6 is given in the following table:

TABLE 2

| Number | SF codeword | Luminance levels (cd/m²) |
|---|---|---|
| 0 | 0000 0000 0000 | 0.1 + 0 × 0.25 + 0 × 1 = 0.10 |
| 1 | 1000 0000 0000 | 0.1 + 1 × 0.25 + 1 × 1 = 1.35 |
| 2 | 0100 0000 0000 | 0.1 + 1 × 0.25 + 1 × 1 = 1.35 |
| 3 | 1100 0000 0000 | 0.1 + 2 × 0.25 + 2 × 1 = 2.60 |
| 4 | 0010 0000 0000 | 0.1 + 1 × 0.25 + 2 × 1 = 2.35 |
| 5 | 1010 0000 0000 | 0.1 + 2 × 0.25 + 3 × 1 = 3.60 |
| 6 | 0110 0000 0000 | 0.1 + 2 × 0.25 + 3 × 1 = 3.60 |
| . | | |
| . | | |
| . | | |

FIG. 1 shows the behavior of the luminance model for each codeword used for displaying the video levels 0 to 255. The curve shows a lot of grayscale inversions, plateaus (same luminance for two consecutive video levels) and non-linearities. For instance, table 2 shows that there is already some codewords having equal luminance model like the rows corresponding to numbers 1 and 2 or the rows corresponding to numbers 5 and 6. Furthermore, some grayscale inversions are already observed like between the rows corresponding to numbers 3 and 4. Therefore, a reordering and modification of this table is mandatory.

As said in previous paragraph, the next step of the Metacode concept disclosed in EP 1 353 315 consists in a reordering of the codes in order to suppress inversion as well as plateaus. In order to do that, new codes called luminance codes or metacodes are selected. Table 3 illustrates this principle:

TABLE 3

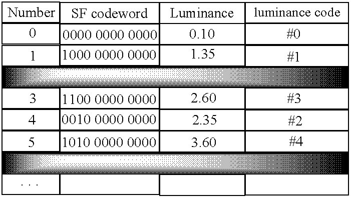

In this stage, a new order #N is defined without any inversion or equality in the luminance levels. In order to do that, the codeword having equal luminance levels are dropped while keeping the best codeword in terms of response fidelity and false contour behavior. This leads to a new basic encoding table as shown below:

TABLE 4

| | | Luminance |
|---|---|---|
| Metacode | SF codeword | (cd/m²) |
| #0 | 0000 0000 0000 | 0.10 |
| #1 | 1000 0000 0000 | 1.35 |
| #2 | 0010 0000 0000 | 2.35 |
| #3 | 1100 0000 0000 | 2.60 |
| #4 | 1010 0000 0000 | 3.60 |
| . | | |
| . | | |
| . | | |

The present invention is about the codedrop principle. The problem encountered for implementing this method is that it requires a huge amount of memory. Below, an example of codedrop process is given:

TABLE 5

| Input | Output |
|---|---|
| 0 | 0 |
| 1 | 1 |
| 2 | 4 |
| 3 | 3 |
| 4 | 5 |
| 5 | 7 |
| 6 | 10 |
| 7 | 14 |
| 8 | 15 |
| 9 | 16 |

The Look up table (LUT) presented in Table 5 represents the implementation of a codedrop concept suppressing in the displayed process the levels 2, 6, 8, 9, 11, 12, 13.

Normally such a LUT needs 256 positions with 8 bit outputs (256×8=2048bits) and this for 256 different AFL values. Finally, it is needed 0.5 Mbit (256×256×8) for one LUT in the external memory. Moveover, each LUT can be different for the three colors, which increases the total amount of memory required to 1.5 Mbit, and this is only for one display mode (e.g. 60 Hz). Furthermore, these kinds of LUTs are also different for each mode used in the PDP (e.g. 60 Hz, 50 Hz, 75 Hz . . . ), which further increases the needs in terms of external memory to 4.5 Mbit for 3 modes.

It is the purpose of the present invention to propose a way to reduce the required data to limit the requirements in terms of external memory and bandwidth.

### SUMMARY OF THE INVENTION

According to the invention, it is proposed to store in the external memory only offset or difference values between luminance codes (these values use less bits) and to regenerate the luminance codes on the chip dedicated for the coding of the video levels.

So, the invention relates to a method for generating subfield codes for video levels in pictures displayed on a display device wherein the video levels is obtained by modulating the number of light pulses per frame or sustain pulses, said method comprising the following steps:

measuring the power average level of the picture to be displayed and distributing the sustain pulses per frame among the subfields of the frame depending on the measured power average level and the subfield weighting,

mapping video levels of the picture to be displayed to luminance codes, and

mapping luminance codes to subfield codes,

According to the invention, for mapping video levels to luminance codes, a first look-up table is computed for the measured average power level, said first look-up table comprising offset values for a plurality of video levels, each offset value associated to a video level corresponding to the difference between a luminance code to be allocated to said video level and another luminance code, and a second look-up table is computed from said first look-up table for allocating a luminance code to each of said plurality of video levels.

Only the first look-up table is stored in an external memory. The present method ensures to reduce the size of this look-up table and, by way of consequence, the size of the external memory. The second look-up table is generated inside the ASIC circuit dedicated for coding the video levels and is stored in a on-chip memory. The size of this on-chip memory is not critical since a maximal of 3 second look-up tables (one for each display mode) with a size of 256×8=2048 bits are stored inside it.

In a preferred embodiment, the offset value associated to a video level n, n>0, equals to the difference between the luminance code associated to the video level n and the luminance code associated to the video level n−1.

To reduce the required memory size again, an offset value is allocated in the first look-up table only for a reduced number of video levels. For example, an offset value is allocated for the M lower video levels among the N possible video levels, with M<N, and a same offset is allocated to the other possible video levels.

The invention relates also to an apparatus for performing the above-mentioned method, wherein said apparatus includes a picture average power measuring circuit, a memory storing said first look-up table, a memory interface unit for reading the first look-up table associated to the measured average power value, a computation unit for generating the second look-up from the first look-up table, a load unit for loading said second look-up table into a transcoding unit used for mapping video levels to luminance codes and a subfield coding unit for mapping luminance codes to subfield codes.

### BRIEF DESCRIPTION OF THE DRAWINGS

Exemplary embodiments of the invention are illustrated in the drawings and are explained in more detail in the following description.

In the figure:

FIG. 1 is a curve showing the luminance associated to each subfield codeword;

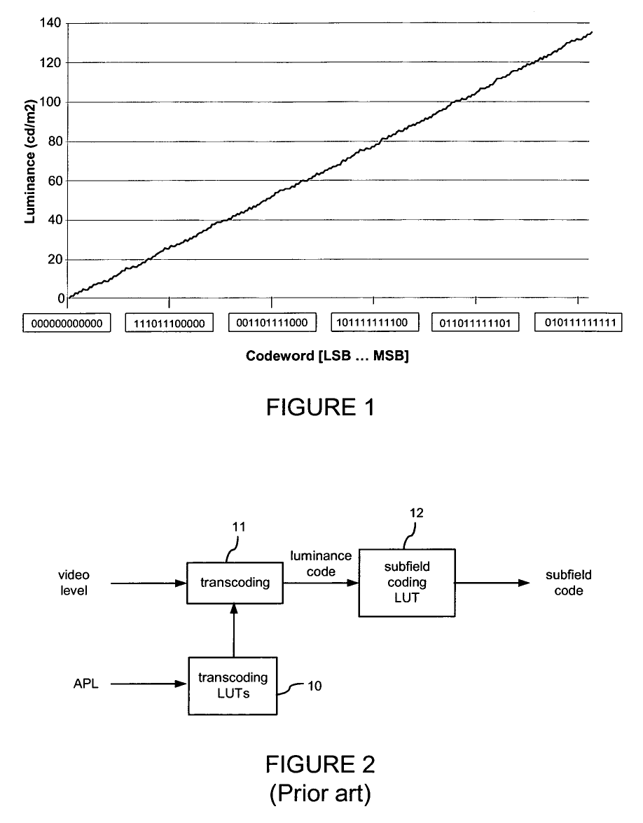

FIG. 2 is a schematic showing an implementation of a prior art method; and

FIG. 3 is a schematic showing a possible implementation of the method according to the invention.

### DESCRIPTION OF PREFERRED EMBODIMENTS

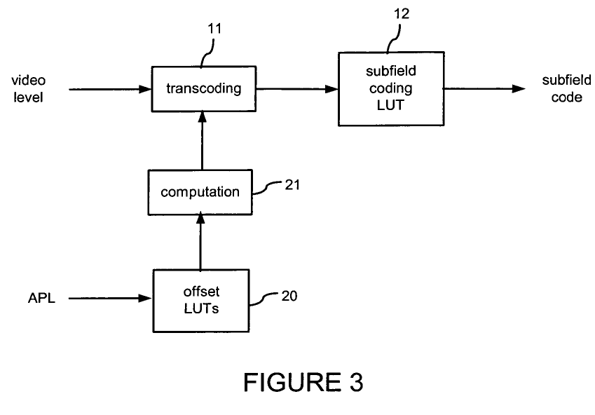

FIG. 2 shows a circuit arrangement for coding the video levels into subfield codes. Transcoding LUTs 10 are used for mapping video levels into luminance codes. A transcoding LUT is associated to each APL value, and if need be, to each color component and each display mode. These transcoding LUTs are stored in an external memory. As previously mentioned, the size of this external memory must be 4,5 Mbit for 256 video levels with 3 colors and 3 display modes. These transcoding LUTs 10 are used by a transcoding block 11 for mapping the video levels into luminance codes. These luminance codes are then mapped to subfield codes by a subfield coding block 12.

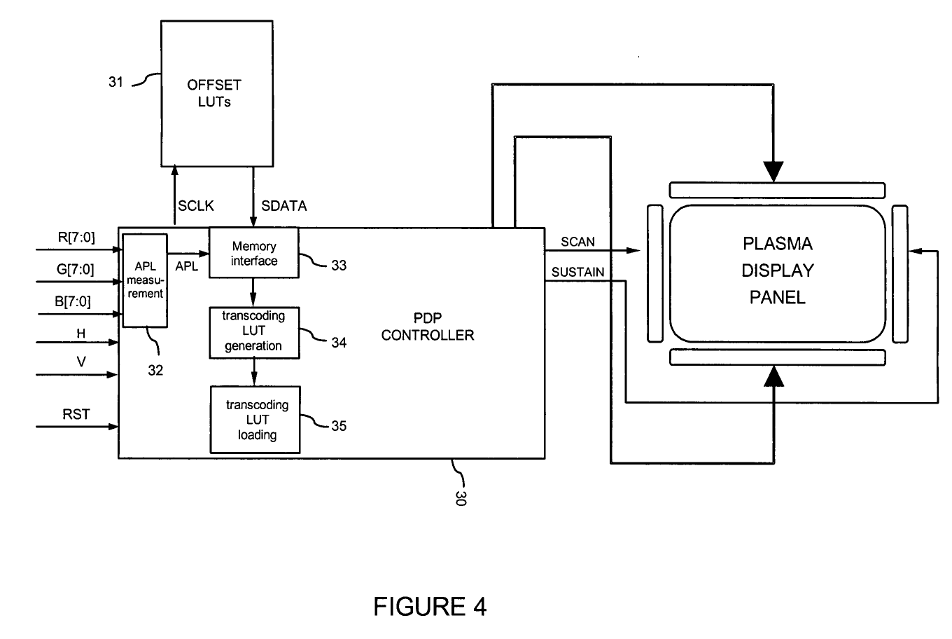

According to the invention, the LUTs used for mapping the video levels into luminance codes are offset LUTs as shown in FIG. 3. In each of these LUTs, an offset value is stored for each video level instead of a luminance code. This offset value for a video level n (referenced Offset(n)) is the difference between the luminance code associated to the video level n (referenced LC(n)) and the luminance code associated to the video level n−1 (referenced LC(n−1)). The offset value associated to the video level 0 is 0. The offset value do not need to be coded on 8 bits. For example, they are coded on 4 bits, the first bit representing the sign and the three other bits representing the offset amplitude. So, the offset value is comprised between −7 and +7. This offset values are used by a computation block 21 for generating the transcoding LUT to be loaded in the transcoding block 11. A transcoding LUT is regenerated at each frame by using the offset LUT associated to the APL value measured for this frame.

Thus, in this example with 4 bit offset values, the required size of the external memory is divided by two, that is 0.256×4×256×3×3=2,25 Mbit.

In an improved embodiment, the size of the external can be reduced again. It comes from the fact the grayscale inversions are only relevant for low- and middle-gray levels; in the high video levels, the grayscale inversions are not visible because of the eye behavior (saturation . . . ). Therefore, it is not necessary to store 256 values in the offset LUTs. For example, only 92 offset values are stored in the offset LUTs which are the offset values for the 92 lower gray levels (0≦n≦91). For the other gray levels n, with n>91, Offset (n)=Offset(91). It will be also possible to store a specific offset value for all the video levels beyond 92.

The required size of the external memory becomes : 92×4×256×3×3=0,8 Mbit instead of 4,5 Mbit.

Another advantage of this method is that the bandwidth required for loading the transcoding LUT generated by the computation block 21 is reduced. The data to be loaded in the transcoding block 11 are only 368 bits (92×4) instead of 2048 bits (256×8). It can be very advantageous when the load operation is carried out during the vertical blanking.

The method of the invention applied to the example given in the preamble of this specification can be illustrated by the following table:

TABLE 6

| | | | Luminance |
|---|---|---|---|
| Video level | Offset | Computation | code |
| 0 | 0 | 0 + 0 = 0 | 0 |
| 1 | 1 | 0 + 1 = 1 | 1 |
| 2 | 3 | 1 + 3 = 4 | 4 |
| 3 | −1 | 4 − 1 = 3 | 3 |
| 4 | 2 | 3 + 2 = 5 | 5 |
| 5 | 2 | 5 + 2 = 7 | 7 |
| 6 | 3 | 7 + 3 = 10 | 10 |
| 7 | 4 | 10 + 4 = 14 | 14 |
| 8 | 1 | 14 + 1 = 15 | 15 |
| 9 | 1 | 15 + 1 = 16 | 16 |
| . | | | |
| . | | | |
| . | | | |

A possible implementation of the inventive method is illustrated by FIG. 4. All the processing blocks (video degamma, subfield coding, serial parallel conversion, controller) are included in a plasma display controller 30, that in most cases is an ASIC. All the look-up tables data is stored on an external memory 31 (EPROM or FLASH) that can be read bit sequentially by the controller 30. In normal operation, at the end of every frame, a new offset LUT data has to be downloaded by the controller 30 depending on the APL value that have been computed during the active part of the video based on R, G and B signals. The APL value is computed in an APL measurement block 32 inside the controller 30. Each refresh operation of the offset LUT inside the controller 30 is based on three blocks: a memory interface 33 that simply reads at a specific address inside the external memory 31 a certain amount of bits corresponding to the offset values associated to the APL value measured by the block 32, a computation block 34 (equivalent to the block 21 of FIG. 3) that builds up the transcoding LUT to be stored inside the controller 30 and finally a loading block 35 in charge of loading the specific transcoding LUT.

The look-up tables stored in the external memory 31 are transferred to the memory interface 33 by using pins SCLK and SDATA of the memory 31 at the end of each frame during the vertical blanking. Indeed, it takes a complete active frame to compute the APL level required to load the right LUTs and it is not allowed to change the content of any LUT during the displaying of active part, otherwise the pictures will lost their homogeneity. Once the new APL value has been determined, the controller 30 requests the required data from the memory 31 and loads the required look-up table data in the memory interface 33.

1. Method for generating subfield codes for video levels in pictures displayed on a display device wherein the video levels is obtained by modulating the number of light pulses per frame or sustain pulses, said method comprising the following steps:
measuring the power average level of the picture to be displayed and distributing the sustain pulses per frame among the subfields of the frame depending on the measured power average level and the subfield weighting,
mapping video levels of the picture to be displayed to luminance codes, and
mapping luminance codes to subfield codes,
wherein, for mapping video levels to luminance codes, a first look-up table is computed for the measured average power level, said first look-up table comprising offset values for a plurality of video levels, each offset value associated to a video level corresponding to the difference between the luminance code to be allocated to said video level and another luminance code, and a second look-up table is computed from said first look-up table for allocating a luminance code to each of said plurality of video levels.

2. Method according to claim 1, wherein the offset value associated to a video level n, n>0, equals to the difference between the luminance code associated to the video level n and the luminance code associated to the video level n−1.

3. Method according to claim 1, wherein the first look-up table comprises an offset value for each the M lower video levels among the N possible video levels, with M<N, and only one offset value ifor all the other possible video levels.

4. Method according to claim 3, wherein the offset value allocated to said other possible video levels is the offset value allocated to the highest of the M lower video levels.

5. An apparatus for performing the method according to claim 1, wherein said apparatus includes a picture average power measuring circuit, a memory storing said first look-up table, a memory interface unit for reading the first look-up table associated to the measured average power value, a computation unit for generating the second look-up from the first look-up table, a load unit for loading said second look-up table into a transcoding unit used for mapping video levels to luminance codes and a subfield coding unit for mapping luminance codes to subfield codes.

6. Apparatus according to claim 5, wherein the picture average power measuring circuit, the memory interface unit, the computation unit, the load unit, the transcoding unit and the subfield coding unit are included in a controller unit of the display device and in that the memory is an external memory.

7. Apparatus according to claim 6, wherein the memory is an EEPROM memory that can be read bit sequentially by the controller unit.

8. Apparatus according to claim 5, wherein the memory interface unit reads the first look-up table in the memory at the end of each frame.
